(19) United States
(12) Patent Application Publication
(10) Pub. No.: US 2025/0165742 A1
(43) Pub. Date: May 22, 2025

(54) ON-METAL UHF RFID TAG

(71) Applicant: Captag Solutions Ltd., Sussex (GB)

(72) Inventors: David Bernard Mapleston, Sussex (GB); Brian Weeks, Sussex (GB); David Christopher Charles Potter, Sussex (GB); Linda Ann Mapleston, Sussex (GB)

(73) Assignee: Captag Solutions Ltd., Sussex (GB)

(21) Appl. No.: 18/839,140

(22) PCT Filed: Feb. 20, 2023
(86) PCT No.: PCT/EP2023/054250

§ 371 Date: Aug. 16, 2024

(30) Foreign Application Priority Data
Feb. 18, 2022 (GB) 2202212.3

(51) Int. Cl. G06K 19/077

(52) U.S. Cl. CPC G06K 19/07786

(57) ABSTRACT

A low-cost long-range UHF on-metal RFID tag uses capacitive coupling means to enhance the range of its monopole antenna structure. Furthermore, the capacitive coupling can couple through a thin insulator directly to the metal surface being tagged or to an optional interposing metallic layer between the tag and metallic or non-metallic items being tagged. These tag embodiments require no dielectric or ferrite material which reduces the cost of the tag without compromising the read range.

### FIELD OF THE INVENTION

This invention relates the field of long-range UHF RFID tags.

### BACKGROUND OF THE INVENTION

Conventional dipole antennas are used extensively in passive UHF RFID tags. However, they will not function when attached directly to a metal object. The current state-of-the-art tags for on-metal functionality utilise spacers, ferrite material, ceramic materials or resonant cavities to isolate the tag from the metal. The current small tags suffer from low read range and the larger tags, which give good performance are inevitably large and costly.

The present inventor has developed an RFID tag that addresses the aforementioned shortcomings.

### PROBLEM TO BE SOLVED BY THE INVENTION

There is a need for improvements in UHF RFID tags.

It is an object of this invention to provide a UHF RFID tag for on-metal functionality which is small and cost-effective to manufacture whilst maintaining a good read range.

It is a further object of the invention to provide a high-performance environmentally friendly disposable on-metal tag.

### SUMMARY OF THE INVENTION

In accordance with a first aspect of the invention, there is provided a long-range UHF RFID tag functional both on and off metal comprises:
a chip comprising a transponder having a transponder integrated circuit;
an inverted-L monopole antenna structure;
a resonant impedance matching structure attached to the antenna, which resonant impedance matching structure is in the form of an elongated resonant means; and
a conductive interposer layer capacitively coupled to the inverted-L monopole antenna structure,
   wherein the resonant impedance matching structure is positioned partly over the interposer and wherein the resonant impedance matching structure is configured to provide frequency tuning of both the antenna and the resonant impedance matching structure to the transponder integrated circuit by moving its position.

In a second aspect of the invention, there is provided a long-range UHF RFID tag for use on-metal, which comprises:
a chip comprising a transponder (e.g. having a transponder integrated circuit);
an inverted-L monopole antenna structure; and
a resonant impedance matching structure attached to the antenna, which resonant impedance matching structure is in the form of an elongated resonant means;
   wherein, in use, the inverted-L monopole antenna structure is capacitively coupled with a metal surface of the article or packaging article to be tagged and the resonant impedance matching structure is positioned at least partially over the metal surface of the article or packaging article to be tagged to provide frequency tuning of both the antenna and the resonant impedance matching structure to the transponder integrated circuit by moving its position.

In a third aspect of the invention, there is provided an article or a packaging article comprising a long-range UHF RFID tag as defined above.

In a fourth aspect of the invention, there is provided an inlay for a long-range UHF RFID tag as defined above, the inlay comprising an inverted-L monopole antenna structure, a resonant impedance matching structure and, optionally, a chip or transponder integrated circuit.

In a fifth aspect of the invention, there is provided a UHF on-metal RFID tag that capacitively couples to the metal item being tagged comprising a monopole antenna means a capacitive coupling means and a resonant impedance matching structure positioned partly or fully under the tag that can be re-positioned to provide frequency tuning of both the antenna and impedance match to the transponder integrated circuit.

In a further aspect of the invention, there is provided a UHF RFID tag as defined in the clauses below.

### ADVANTAGES OF THE INVENTION

The cost of manufacturing a UHF RFID tag of the present invention, and the embodiments described herein, is much lower than the current state of the art and, in most cases, the tag is smaller in size. This is achieved without sacrificing range, whilst exceeding other important performance properties.

### BRIEF DESCRIPTION OF THE DRAWINGS

FIG. 1 shows a UHF RFID tag according to one embodiment of the invention in which the support structure has a plastic frame;

FIG. 2 shows another view of a UHF RFID tag of the embodiment of FIG. 1;

FIG. 3 shows an inlay for use in the tag of the invention;

FIG. 4 shows a UHF RFID tag of another embodiment of the invention;

FIG. 5 shows a UHF RFID tag of another embodiment of the invention; and

FIG. 6 shows a graph of range in metres against height from metal in mm for a tag of the invention.

### DETAILED DESCRIPTION OF THE INVENTION

The invention is as defined in the Summary of Invention above.

This invention uses an inverted-L monopole antenna in conjunction with capacitive coupling to the metal being tagged or to a conductive interposer layer to achieve a long read range.

This description contains three principal embodiments of the invention: a standard on-metal tag using a plastic support frame, an eco-friendly tag containing no plastic and a tag invention that uses the shipping box or the internal packing materials as its main structure.

One important embodiment shown is a high-performance environmentally friendly disposable on-metal tag.

The following abbreviations and definitions are used herein:
UHF=Ultra High Frequency. >100 MHz; usually 866 MHz in Europe and 916 MHz in the USA
NFC=Near Field Communication. Uses magnetic coupling between coils. 13.56 MHz worldwide
Inlay=This is the carrier for the chip; usually aluminium on plastic with the silicon chip in a loop on the surface. The inlay preferably also carries the antenna for the tag. Some inlays have a peel-and-stick backing option; in some cases, this is the complete tag (in that the article or packaging article to be tagged provides the necessary structure).
RF=Radiofrequency
HF=High frequency, usually 13.56 MHz for short-range card transactions etc
IC=Integrated circuit.
Chip=Same as ‘Integrated circuit’ but without encapsulation
RFID=Radio Frequency Identification. Sometimes referred to as RAIN RFID
Interposer=a metal plate or foil to be disposed between the inverted-L monopole antenna structure and the object to be tagged
Lambda=The wavelength of the radio signal L=C/F in a vacuum or free space
EAS=Electronic article surveillance used in shops to deter theft
Back Scatter or reflected signal=UHF RFID tags have no batteries; they rely on the power transmitted by the reader and then modulate the reflected signal with data back to the reader
Capacitive coupling=At UHF frequencies two flat surfaces close together will form a capacitor capable of transferring the power of the signal through thin sheets of plastic and or paper with ease. This enables structures to pass electrical current without metal-to-metal physical contact.
RAM=random access memory. This is on the silicon chip for the storage of the user data etc.
‘Q’ factor=the sharpness of the tuning, this is also the bandwidth of the RFID tag
Dipole Antennas=two antennas on either side of the chip. The resulting tag tunes to lambda/2
Monopole antenna=a single antenna with length lambda/4
Inverted-L Monopole=This is a monopole antenna which is bent over somewhere along its length, it is sometimes referred to as a bent-monopole. Usually, the bend is 90 degrees.

Preferably, the tag of the invention further comprises a supporting structure and optionally an inlay for the supporting structure and, disposed on the inlay, the inverted-L monopole antenna structure, the resonant impedance matching structure and, optionally, the chip or transponder integrated circuit. Preferably, the inlay further comprises a capacitive plate at the lower or opposing side or end to the antenna structure.

The tag of the invention preferably comprises an interposer layer disposed on an opposing surface of the supporting structure to the inverted-L monopole antenna structure, or a bottom surface of the supporting structure, thereby capacitively coupling with the inlay and, in particular, the capacitive plate of the inlay.

In one embodiment, the support structure is discrete from an article or packaging article to which the tag is to be applied. As such, the tag, including a support structure and the interposer layer, can be disposed on an article or any article packaging for which a tag is required.

In another embodiment, the support structure forms part of an article or packaging article on which the tag is formed or is to be formed. In this embodiment, an inlay layer comprising an antenna, resonant impedance matching structure and optional capacitive plate, may be disposed on part of a packaging article acting as a support structure and preferably folded over an edge therefore and disposed on or over a interposer layer (which may be a foil tape, for example) so that at least a portion of the resonant impedance matching structure overlaps the interposer layer, in order to form the tag.

The inlay may be of any suitable material.

In one embodiment, the inlay is free from plastic and other polymer materials.

The supporting structure may be of any suitable material, but is preferably free from ceramic and ferromagnetic material, as is the tag as a whole.

In one embodiment, the supporting structure is free from plastic or other polymer materials. Optionally, the supporting structure is cardboard or corrugated cardboard. Preferably, such a tag which also has an inlay with a non-plastic substrate is provided, which is a plastic-free environmentally friendly tag.

In another embodiment, the supporting structure comprises a foam of any type, such as box packing material.

In another embodiment, the supporting structure comprises a plastic or any polymer.

The supporting structure may be any material that has a low conductivity and low permeability, such as dry wood.

Preferably, the resonant impedance matching structure is an elongated resonant structure with its length and width ratio set so that when tuned by its position over the interposer the length of the attached antenna is also changed so that the antenna tuned frequency tracks with the resonant impedance matching structure's tuned frequency.

In one embodiment, the tag is configured to use a a metal surface of an article or packaging article to be tagged to re-tune the resonant impedance matching structure and inverted-L monopole antenna structure providing different tuning when the tag is on or off metal.

Optionally, and preferably, the long-range UHF RFID tag incorporates an NFC (Near Field Communication) tag of any type.

Preferably, the tag comprises a single chip contains both UHF and NFC transponders.

Preferably, the tag comprises a UHF transponder circuit and optionally an NFC transponder circuit and further comprises a tamper detection loop means either on the UHF transponder circuit or the NFC transponder circuit.

Preferably, the tag comprises a UHF transponder circuit and optionally an NFC transponder circuit and further comprises a temperature detection means on either the UHF or NFC transponder.

Optionally the long-range UHF RFID tag has a frequency of operation that is in one or more of: the worldwide bands for Bluetooth transponders; the worldwide bands for Wi-Fi transponders; and the worldwide bands for mobile communication.

In a preferred embodiment of the invention, the interposer is elongated so that the inverted-L monopole antenna structure is a half lambda resonant length when off-metal to improve off-metal performance.

In another preferred embodiment, the interposer is elongated by the addition of meanders of any shape to improve the off-metal performance.

Preferably, in any of the above embodiments, the long-range UHF RFID tag is free from ferromagnetic and ceramic material.

To improve the off-metal performance of all the embodiments described, the interposer can be elongated so that when the tag is off metal the structure tunes at half lambda. This requires a total antenna length of approximately 17.2 cm. The tag then acts as an inverted-L monopole when on-metal but miraculously changes to a dipole when off-metal.

The total length of the tag can be shortened considerably by adding meanders (squiggles) to the interposer. This important inventive step is not obvious to experts in the field; adding meanders to the antenna to shorten antenna lengths is well known; however, adding meanders to a capacitive couples interposer is novel. This addition to the interposer shape has been successfully tested with tags just 7 cm long giving equal and exceptional on and off-metal performance.

The invention will now be described in more detail, without limitation, with reference to the accompanying Figures.

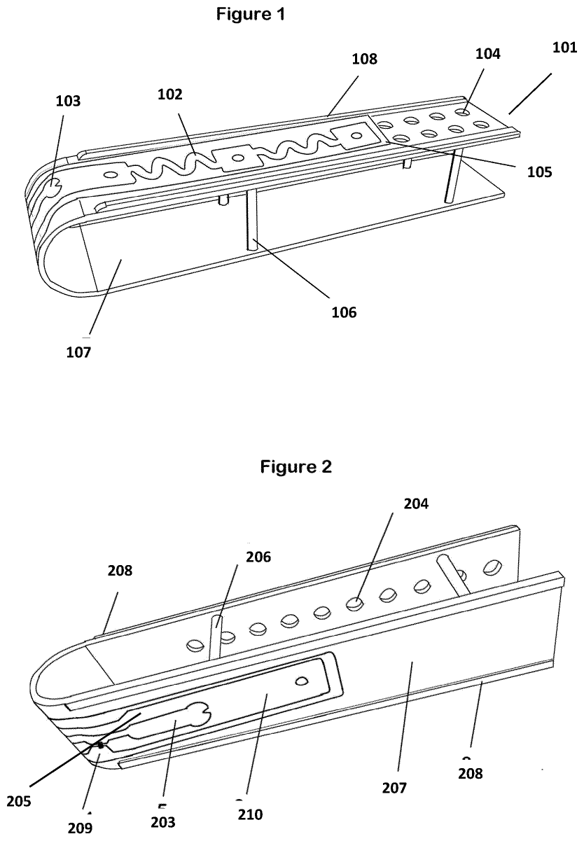

In FIG. 1, a tag 101 of the invention is shown (without illustrating an interposer or metallic article to which the tag is to be applied) having a plastic support structure. The plastic support structure or frame 107 would normally have sides attached, a printed paper or plastic covering with text and a peel-and-stick base. (All these additions have been fabricated and tested successfully).

This embodiment has been left open to show that no inside materials are required. In fact, the best performance is achieved when nothing is inside the tag. This is not the case with most other on-metal tags.

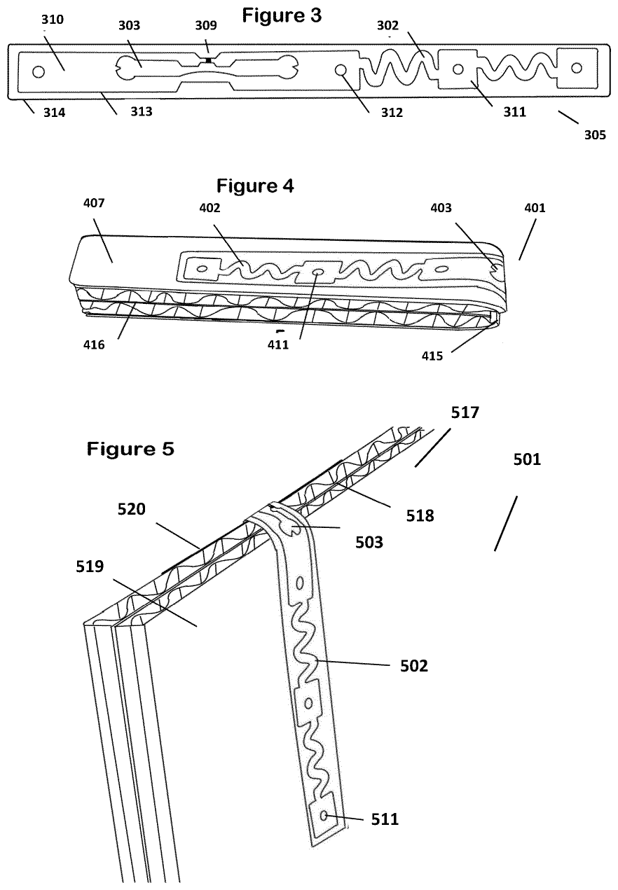

FIG. 1 shows the two basic parts of the tag 101 fitted together. The inlay 105, 305 shown in FIG. 3, is attached to the frame 107 which is the supporting structure to make the completed tag 101 (subject to interposer layer—not shown). This structure can be attached directly to metal needing tagging to form the completed tag 101 or it can be attached to an optional metallic interposer (520 in FIG. 5). The interposer 520 is a conductive sheet, for example baking foil, and it allows on and off-metal functionality.

A specialised elongated resonant impedance matching structure 103 is positioned with a percentage of its length on the underside of the plastic frame 107 or on the opposing side to the antenna 102. The amount of this structure 103 placed on the opposing face of the tag 101 and so sandwiched between the frame 107 and the metal or article to be tagged affects the resonant frequency of the tag's matching network. Approximately 10 MHz per mm is achieved at 866 MHz. This repositioning variable is used to fine-tune the tag 101. This feature is present in all embodiments described.

The tag's antenna 102 is formed as part of the inlay 105; in this example, it has a meandering path sometimes called a squiggle antenna. The optional squiggles introduce inductance within the antenna 102. This has the following benefits: first, it reduces the length of the antenna 102 and second it reduces the antenna bandwidth which in turn reduces the level of interfering signals and improves the signal-to-noise ratio. This is known and usually referred to as the ‘Q’ factor.

Plastic rails 108 are part of the frame 107, they add rigidity and also protect the inlay 105 from damage. There are optional holes 104 in the plastic frame 107 which reduce the detuning of the antenna 102 by the plastic frame 107. At these frequencies, electrons exhibit a skin effect that causes them to travel over the surface of the metallised antenna. When moving in the plastic the electron mobility is affected by the permeability of the plastic frame which then affects the tuned frequency of the tag.

In a production embodiment, the construction could be a simple box containing air. The top holes are sealed by the plastic inlay to prevent water and or insects from entering the empty chamber-they would both be detrimental to the tag's performance. Inlay 105 is optionally a peel-and-stick structure. It contains the antenna 102, resonant impedance matching structure (or circuit) 103 and a capacitive plate area 210 (in FIG. 2). It is shown in detail in FIG. 3 and used in all the embodiments described in this description.

The conductive inlay 105 shown may typically be aluminium on a thin plastic film with a paper covering. However, it may be, for example, metal on paper inlays, which we have recently tested with excellent results. Minor frequency changes were required that can be easily compensated for by changing the inlay 105 position.

Supporting rods 106 may optionally be used so that the frame 107 maintains its shape. In a covered embodiment (in some embodiments, the illustrated structure will be disposed within a plastic body-not shown) or an embodiment with sides, (not shown), these supporting rods 106 would not be required.

The plastic frame 107 serves to hold the inlay 105 in the optimum position. A frame 107 of 1 mm thick plastic was tested. However, a frame 107 of just 0.5 mm thick (shown) has enough strength and rigidity for most applications.

FIG. 2 illustrates an embodiment very similar to that of FIG. 1 from and underside. In FIG. 2, inlay-protecting rails 208 are illustrated on the top and bottom of the plastic support frame 207. The supporting rods 206 useful for improved strength are also illustrated. Again, they are not required when sides are added to the structure or the structure is encased.

Optional holes 204 are shown here going all the way through the support frame 207. An alternative to the embodiment has holes partly through the structure to prevent water or insect ingress. In another embodiment, the frame 207 or parts of the frame 207 are made from a mesh structure to reduce material cost, prevent de-tuning and maintain the quality factor ‘Q’ factor of the antenna.

Silicon chip 209 that is known to the art is illustrated. Many examples exist and can be used in this invention. The performance is enhanced when using chips that have adaptive switched capacitor tuning, such as the NXP® Ucode 8 and Ucode 9. The adaptive tuning gives the tag 201 a wider bandwidth to enable multi-channel reception or create world tags that are region independent.

These chips 209 contain the radio transponder, the rectifier for the power supply, the permanent code and the user-changeable code in RAM. Their main function is to modulate the reflected signal by connecting and disconnecting the antenna 102 which then modulates the backscatter RF signal. Other functions can be selected by writing to internal registers in the chip 209.

Some chips have tamper loops built-in for security and some also have NEAR FIELD functionality which is smartphone readable. This is useful for customer engagement and ease of tag setup. Dual-frequency chips have the UHF radio at 866 MHz to 950 MHz and the NFC tag circuit used at 13.56 MHz; they have been on the market for over 10 years and they also allow a smartphone to set the UHF user data.

Other on-metal tags cannot use the NFC capability as the NFC coil antennas also require space from a metal surface.

Dual-frequency and tamper loop embodiments have been tested successfully. The introduction of an NFC tag on the top, as part of the UHF antenna, works with the full range due to the large air gap which separates the NFC tag from the metal of the object being tagged. It can be connected to form part of the UHF antenna structure and length.

The resonant impedance matching structure 203 is a resonant slot in the metal layer of the inlay 205. Its shape has been devised so that when half of this tuned structure is close to metal the tuned frequency is in the middle of the tagging frequency allocations for the USA and Europe. This tuned cavity transforms the impedance from the base of the antenna to create an efficient power transfer (match) into the silicon chip's capacitive and resistive input impedance. This is known as complex conjugate matching.

The principle of tuning an on-metal tag by moving more of this tuned structure against the metal to be tagged or metallic interposer layer is believed to be new and inventive.

Part of the inlay 205 is an inlay capacitor plate 210 providing one plate of a coupling capacitor. In this embodiment, it couples through the inlay plastic and the paper covering, normally over the inlay 205, to the other capacitive plate. The other plate can be the metal item being tagged or an optional interposer layer (e.g. 516 of FIG. 5).

This capacitor, between the inlay 205 and the metal being tagged (or the metallic interposer layer), works across the gap between the base of the inverted-L monopole antenna and the RF reflective surface of the metal to which the tag is attached (or the interposer layer). When the tag is encapsulated, the encapsulation thickness under the tag should be as thin as possible. Some pre-tuning may be required to offset the frequency shift caused by the increased material between the tag and the metal surface.

This capacitor is not a tuning component, its function is to bridge the insulated gap between the tag and metal and so allow the inverted-L monopole antenna to function with the benefit of its antenna's radio reflection in the metal. All the embodiments work with a standard monopole as well as the inverted-L monopole, however, a standard monopole would be too high from the metal surface and would give poor results when the reader antenna was directly above the tag.

The embodiments will also perform well with an angled monopole; however, nothing has been found which gives the best all-around performance as the inverted-L monopole.

Even though there is no direct connection between the tag and the metal, the inlays capacitive plate 210 has been designed so that enough current flows across the gap to the object being tagged (or the optional interposer) so the metal still acts as a ground reflector and increases the efficacy of the antenna. This increase in efficiency is very substantial and is theoretically almost twice the efficiency of a dipole twice its length; even when the dipole is in free space.

This is explained in more detail later as it is not easy to understand how an antenna half the size of a dipole can have twice the performance.

The support frame 207 for the inlay 205 is for support only and can be made from any material which exhibits a low permeability and has adequate structural strength. A permeability ‘Er’ of less than 3 is recommended as this requires little or no retuning of the tag; especially if the holes or a mesh is employed in the top surface. Holes can also be applied to the bottom part of the structure; however, these may compromise adhesion to the metal surface and so are not shown in this preferred embodiment. This support frame can be used inside a strong housing for applications requiring robustness and weatherproofing.

The primary purpose of the bottom rails 208 is to protect the inlay and silicon chip from damage; however, they also provide some extra structural support; they help with adhesion and prevent the tag from rocking from side to side on the inlay and chip.

A further enhancement to the support structure 207 is the addition of a narrow trench 0.2 mm deep in line with the silicon chip 209. This also prevents the rocking of the structure 207 on the silicon chip and prevents the crushing of the chip 209 when the tag is applied to a metal surface. A trench is used so that the tag can be tuned by moving the inlay 205 location.

This tag can be fixed to a metal object using strong double-sided tape or screws through the bottom section or by attaching wings to the sides or ends of the support frame 207 to take fixing screws.

In a more robust design, the supporting structure 207 is placed inside a housing that can have a myriad of fixing positions and fixing methods. The tag can be pre-adjusted by moving the position of the inlay 205 to compensate for the frequency shift caused by the housing if any.

FIG. 3 illustrates inlay 305 that is fitted to the frame 105, 205 described above. It can be made from metal on plastic; or more recently, metal on paper. This construction has been successfully tested.

The inlay 305 has the following key features to improve performance for on-metal tagging applications:
a) The antenna 302 has been elongated and so would not tune in normal tag applications; however, it has been designed to tune when the monopole antenna is bent over and close to the metal surface it is tagging; (or, to the optional interposer reflector layer). When the inlay 305 is bent over, the antenna 302 becomes an inverted-L monopole.
b) The inlay capacitive plate area 310 (and 210) has been increased to the required area to provide enough capacitance and hence enough current flow through the inlay to power the RFID chip transponder.

This inlay is a tag in its own right.

The inlay 305 shown in FIG. 3 is an example of the preferred embodiment; however, other inlays could provide similar functionality but they would not be ideal.

The capacitive coupling area 310 couples through the thin plastic inlay layer 313 of the inlay 305 and the paper decals 315 to the item being tagged, or to the optional interposer (not shown). It is not used for tuning purposes; it is required so that enough current can flow to power the chip. This capacitive coupling increases the efficiency of the monopole antenna 302 which is at the top of the support frame.

It is worth noting that other on-metal tags function differently on different metals. As this embodiment only uses the metal as a reflector the functionality when on different metals is very similar.

The resonant impedance matching structure 303 is illustrated. This may also be referred to as the resonant slot, sometimes called a 2D resonant cavity, it is also sometimes called a tuning loop and sometimes referred to as a matching transformer. Its task is to resonate with the chip's input impedance at the required frequency. At this frequency, it should transform the impedance from the bottom of the antenna to the complex impedance of the RFID chip.

This elongated inlay 305 (or a similar resonant structure) provides, for on-metal applications, placement against the metal being tagged (or a metallic interposer layer). The structure (dog bone shape) Should be partly on an underside the tag's support structure (or an opposing side to the antenna 302) so that an amount of the metal being tagged or the interposer covers some or all of this resonant structure. Its position can then be used to tune the complex impedance match to the correct frequency.

The tuned matching structure will rise in frequency as more of this matching structure covers the metal being tagged.

This provides a means of tuning the on-metal tag to different country regions as the operational frequencies differ around the world between 866 MHz and 950 MHz.

This tuning step is further enhanced by the fact that when the matching network is rotated further under the structure, to raise the matching tuned frequency, the antenna 302 is consequently shortened in length. This raises the tuning frequency of the antenna 302 at the same time the matching network (or resonant impedance matching structure 303) is raised in frequency.

This tracking of the antenna tuning with the matching network tuning is another important benefit within these embodiments. This tuning also allows a single inlay design to cover all world regional frequencies. Also, it simplifies tuning changes to compensate for application tuning offsets caused by encasement of the embodiments or implementation of the embodiments inside items.

In the meandering Inverted-L monopole antenna 302 shown, the number of squiggles can be increased to reduce the length of the tag if required. Optional square metallised areas with optional holes 311 can be used for alignment for this and other embodiments. The accuracy of the placement of the inlay 305 on the frame is crucial to the functionality. Tests show that 1 mm accuracy is required to get within 10 MHz of the target frequency. In the USA there are 50 channels spaced 400 kHz apart and so the accuracy of the inlay placement on the frame is not as important as in other regions.

Optional alignment holes 312 help align the antenna position. The antenna position can be fixed accurately using holes punched in the inlay 305 which fit over standing posts about 1 mm high. These may be useful as the tuning required by the tag needs to be within 1 mm for full accuracy and hence full read range.

In an extended embodiment, this hole is a long slot with frequency or region markings. This enables suppliers or customers to stock inlays and frames and easily set them for the target country or world regions.

The metallised plastic inlay layer 313 forms the inlay. The preference for the future is for the metallisation to be on a paper backing so that an eco-friendlier tag (e.g. in FIG. 4) can be manufactured.

An optional paper decal 314 could carry the logo and other information; for example, a bar code or QR code. The printed paper can be folded under the tag with the inlay and does not cause a noticeable reduction in the tag's performance.

The tag can be manufactured with a peel-and-stick surface on the underside so that it can be attached easily to the metal surface or interposer.

FIG. 4 illustrates an embodiment of the invention using corrugated cardboard as the support structure 407. In this embodiment, the inlay 405 described in FIG. 3 (305) may be used. As well as corrugated cardboard, any similar cardboard or paper structure can be utilised.

A conventional plastic inlay 305 can be used; however, an inlay 405 should preferably be used that is constructed of metal on paper. With this construction, the tag 401 can be advertised as totally eco-friendly as no plastic or banned substances would be used in its construction. The materials would simply be silicon, card, paper, glue and aluminium. With today's rightful goal of reducing plastic in the environment, the invention of a long-range, single-use, on-metal tag with no plastic is an important benefit.

The support structure 407, as mentioned above, is of a corrugated cardboard support structure. No measurable performance degradation was seen using cardboard instead of the plastic frame 107,207.

The position of the inverted-L monopole antenna 402 could be marked on the top of the support structure 407. The text and scale could be printed so that the tag can be set easily for different regions and frequencies.

The resonant impedance matching structure 403 is illustrated. This eco-friendly embodiment works the same way as the plastic embodiment. All the tuning and range advantages are the same as with the plastic support structure.

Inlay 405 extends over the pre-cut double corrugated cardboard edge 415. The embodiment illustrates two layers of cardboard 416. Another construction method is to have one single layer of corrugated cardboard folded over at this point. They can then be stuck together to form a structure with no cardboard gap; however, this would only be for ease of assembling and aesthetics as it gives no noticeable performance advantage.

Optional alignment holes 411 are provided for positioning the inlay 405 accurately on the corrugated cardboard support structure 407.

As mentioned, the two layers of corrugated cardboard 416 give an improved performance. One layer gives good performance at approximately 3.7 meters (EU regulations EN302-208 low band); however, two layers give an exceptional performance at about 9+ metres and even greater performance can be achieved with 3 layers; with tags reading at 14 metres. These figures are exceeded in the USA by 10% and using the EU 916 MHz high band they are exceeded by about 22% in range.

In FIG. 5, a box folding lid 517 provides the support structure.

A box lid can be converted into an on-metal tag using this invention.

A plastic or cardboard box can be used as the support structure for the inlay 305, shown in FIG. 3. The box closing flap 518 forms the on-metal tag. Although this is the easiest location for the tag; any other location on the box, where the tag can be folded and easily applied is applicable.

Note, without the interposer layer 520, the tag 501 would give a poor range, however, when metal is inside the box and it comes close to the tag 501 the range will increase considerably; this is opposite to conventional dipole tags when used on boxes.

With a layer of thin foil 520 the tag's performance is excellent and not affected by the contents of the box; metal or otherwise. The metal interposer 520 is for use on-metal as well as off-metal. This is how we have constructed an on-off metal embodiment. The interposer 520 does nothing when on metal; however, it replaces the function of the metal item when the tag 501 is not on metal.

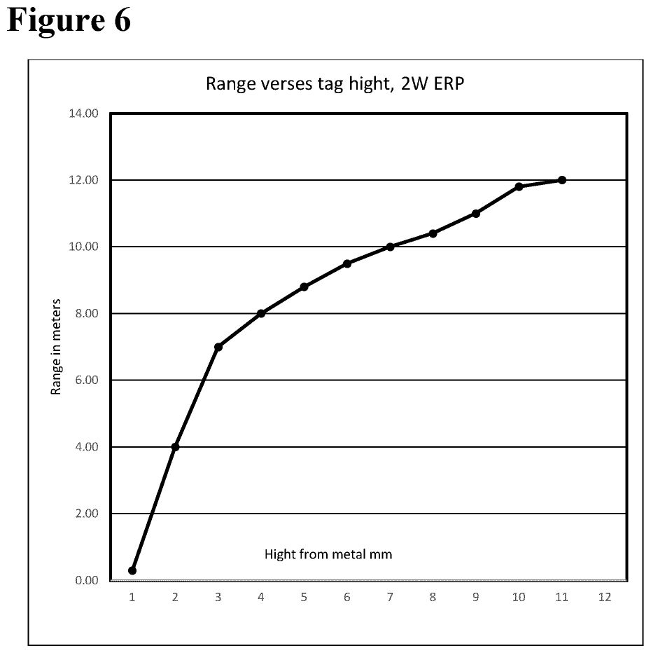

In the example shown in FIG. 5, one of the fold-down flaps 518 at the top of a double corrugated shipping box has been converted into an on-metal tag. The invention also works on single corrugated cardboard; however, the read range is more than halved. See FIG. 6 for the estimated range.

Note, the range figures stated are defined by the current state-of-the-art chips; however, as transistor feature sizes of the integrated circuits become smaller, the ranges given in FIG. 6 may be doubled, or more in the near future.

In FIG. 5, one of the four folding flaps 518 at the top of a box or container, which could be single corrugated cardboard with less range or triple corrugated which would give an exceptional range (14+ metres). Unfortunately, the range is less than stated on the graph of FIG. 6, unless the flap is closed to within a few millimetres of the metal contents. However, this problem is easily solved by the introduction of the interposer layer 520. In one single-layer corrugated embodiment, another layer of corrugated cardboard is placed and fixed, to the underside of the flap before the inlay is applied; this will extend the range of the tag at very little extra expense. This extra corrugated piece can have metal film pre-applied to one side to form the interposer. As the inlay capacitive plate can go under or over the interposing metallic sheet, the inlay can be applied after the interposer is in place.

If required, the interposer metal can cover the whole closing flap or even the whole of the inside of the box. Theoretically, the full range is achieved when the interposer is (Lambda/4)×(Lambda/4) in area and so about 8.6 cm square; however, research has shown that smaller areas still give a substantial range improvement.

The resonant matching structure 503 is positioned over the edge 518 of the flap 518 and can be adjusted to tune the tag 501 to the desired frequency.

The meandering Inverted-L monopole antenna 502 is shown, which can be made even shorter with more squiggles or can be made wide-band with no squiggles. However, the tag 501 would then be much longer; around 8.6 cm long for EU operation and only slightly less for the USA.

The end of the elongated antenna 502 has optional alignment holes 511 so that the tag 501 can be applied at right angles to the cardboard edge and in the correct place. The angle of the tag is not critical to the operation. The targets for alignment can be pre-printed on the box.

The top surface 519 of the corrugated lid must be free from metallised stickers or other tags. This invention is not restricted to the lid of the box, the inlay can be placed within the box on cardboard packing or foam packing material within the box. For the full range, with any contents in the box, the interposer layer 520 would be required.

The metallic interposer 520 is disposed between the inlay (or tag 501) and the contents of the box. This interposer 520 has been mentioned above, it solves the on-off metal problem and so makes the tag 501 useful in a myriad of applications. One new application is in what is known as slap and ship applications where the contents of the box are not known or cannot be controlled.

The interposer 520 is a thin metallised sheet or plate, ideally, >8 cm×8 cm and fixed to the underside of the box's closing flap. An area of metal smaller than 8×8 will still result in a good performance but will be more directional than when a larger area is used.

With the interposer 520 the same size as the tag base the functionality is still adequate for most applications. This enables an embodiment where the interposer is already applied to the tag before use, this then becomes an on-anything RFID tag. This also applies to all previous embodiments.

The thin interposer 520 can be applied before or after the inlay is applied to the box as it functions the same when on top or below the inlay's capacitive tail area. This interposer 520 solves one of the major problems when tagging shipping boxes or containers. The problem is that standard RFID tags are only reliable when you know the contents of the box you are tagging. If the contents are non-conductive or you are confident that any metal in the box will not come within 4 cm of the tag, then a conventional dipole tag can be applied to the box; however, if the contents are random then your read results will also be random.

By simply placing a metallised interposer 520 under the embodiments described means that the contents of the box are irrelevant to the functionality of this tag. Although the interposer 520 is not physically connected to the inverted-L monopole, the capacitive connection is enough to create a reflective image of the monopole in the interposer, resulting in full range, no matter what is inside the box: metal, fluids, tyres or food etc.

FIG. 6 illustrates a graph of range against tag height. A 10 mm plastic frame or cardboard support can give a 12 to 14 meters range.

Another embodiment of the invention uses packing foam as the structure for the inlay; although not as eco-friendly it gives similar performance to the corrugated cardboard but with the added advantage that the foam will spring back to the required thickness if accidentally crushed.

The best packing foam for this application should spring back to shape while having the largest air-to-material ratio possible.

This embodiment is ideal for use inside cardboard shipping boxes; with the addition of the interposer, the shipping box can contain any items, metals or non-metals.

Other low-dielectric materials can be used as the support frame for the inlay, as long as they are fit for the target application and have a low dielectric constant. A simple cardboard box for example gives excellent results.

The RFID on-metal applications for this invention are limitless! An eco-friendly, on-anything single-use and low-cost tag, has been the holy grail of the RFID industry for many years. These and other embodiments of this invention approach this goal.

The term ‘Slap and ship’ has been used for companies that simply apply tags to boxes and hope for the best. Now combining two inventive steps, namely the capacitively connected inverted-L monopole and the separate optional interposer, tags can be used as part of the box or constructed using the packing material inside the box. The box can then be shipped without worrying or even knowing about the contents, with the knowledge that the RFID tag will still perform as specified, regardless of what is inside the box or even the material the box itself is constructed from.

In another practical embodiment, a combination of these inventive steps uses a foam support structure with a small metallic interposer; this can create a slap and ship tag on the outside of any box as long as it has 60 mm length on one side. If squashed the foam re-expands to provide the full read range again. This provides a solution for the top or sides of drink cans enabling them to be used in automated vending machines etc.

For applications using thin cardboard boxes, metallised peel-and-stick foam can be employed. For example, one piece of metallised floor insulating material, used under laminate flooring, can be made into 100+ tags ideal for use inside a box, on the outside, or applied to a closing flap before the inlay is applied. The tag can also be applied to the underside of the flap; with the antenna fixed to the cardboard flap. A small amount of re-tuning would be advisable when the antenna is touching the cardboard

### Radio Theory Describing How the Tag Embodiment Works so Well

The tag embodiments described are using a little-known aspect of monopole antennas. The mathematics is tedious but can partly be found if searched for directly in Wikipedia®. The published mathematical analysis found, only applies to straight monopole antennas. The following section is a brief and simplified explanation of the known theoretical enhancement obtained when using a monopole antenna for on-metal tagging.

A standard monopole antenna performs very poorly in comparison to a dipole; this is exactly as expected simply because the dipole antenna is twice the size of a monopole antenna and so tunes to lambda/2 rather than the monopole which tunes to lambda/4. However, when the monopole is above a ground plane it's a different story; the performance of the monopole is then dramatically improved.

The reason for this is that the metal ground under the monopole creates an inverted mirror image of the monopole underneath the ground plane. In our preferred embodiments, the ground plane is the metal object being tagged; however, when this cannot be relied upon, the interposing metal sheet or plate can be used below the tag to act as the ground reflector. The metallic sheet can be aluminium-foil for example.

The performance of the monopole on a ground plane is outstanding and a surprise to many radio and RFID engineers.

The reflection of the monopole, created by the ground plane works with the upper monopole to create a single dipole antenna. So, many experts in the field can be forgiven for thinking that this dipole works the same way as a normal dipole; however, this is not the case. A dipole has radiation resistance in each arm (Rr), which restricts its ability to transmit and receive signals. The grounded monopole also has radiation resistance in the real monopole at the top of the metal; however, the image, below the ground plane doesn't exhibit any radiation resistance. This imaginary antenna has no radiation resistance, crazy though it may sound, the image of the monopole works better than the real existing monopole.

So, in comparison, the grounded monopole it has a total radiation resistance of half that of a solid real dipole. Could this mean that the shorter grounded monopole can transmit and receive twice as efficiently as a real dipole?

Surprisingly the answer is yes! The grounded monopole has 3 dB power gain over a dipole and this results in 25% more range. Remember that this is from an antenna half as long as the dipole.

In fairness to the dipole antenna, it should be pointed out that we are analysing on-metal tags which are only required to transmit and receive above the ground plane, where a free space dipole transmits and receives above and below its centre line.

As antennas are governed by the reciprocity theory, the reflected modulated signal from the tag is also 50% more efficient. However, in most cases, the range of the tag is dependent on the current the RFID chip is taking to turn on; so, we do not see the 25% range improvement from the backscatter signals improved efficiency. This is primarily because the reflected signal is already easily detected once the chip is up and running, so the return path usually doesn't become a limiting factor on the range in the first place. However, in enclosed environments containing fluid or dense absorbent material the 3 dB extra return path efficiency benefits tag detection when antennas other than the antenna powering the tag are actively looking for the tag's backscatter signal.

When used with a small interposer this invention works against the human body and so could be used for events; for example, on runners or cyclists. Obviously, the interposer would not be required for motorcycles or cars unless they are fibreglass for example.

Our experiments show that bending the monopole causes it to detune to a lower frequency. If the monopole is extended until it tunes again, most of the efficiency returns. When the antenna is bent down 10 mm parallel to the metal, the tuned frequency goes down by approximately 30 MHz. Bending the tag will also cause the field pattern to change. This bend creates a better field pattern than the vertical monopole as reading from above a straight upright monopole can be difficult as the antenna is in an end-on orientation. One practical example is an on-metal tag, using these inventive steps 10 mm high×9 mm wide and 60 mm long. The range from above is comparable to the read range from the sides which is in the order of 12 meters.

In a special embodiment, the monopoly can be set at an angle, away from the metal to be tagged; this improves performance from the sides, at the expense of performance from overhead. This is obvious and known in the art; however, it is still a useful feature as it allows the beam angle to be directed to fit some very difficult applications.

As shown in the graph, FIG. 6, the range drops considerably as the tag height from the metal is reduced. However, a tag just 1.3 mm high gives a 3-meter range. A very thin tag will always give some range because when the antenna is within 20 cm or so of the tag, reading is achieved by near-field communication means. This utilises the magnetic part of the electromagnetic wave rather than the long-range electric part of the electromagnetic wave. The magnetic field drops off as the cube root of range rather than the square root of the range associated with the electric field and so this magnetic energy is only available close to the transmitting antenna.

Note, that all the embodiments described are achieving a near omnidirectional field pattern. Some on-metal and most off-metal RFID tags have end-on-read issues. This manifests itself as two reading dead zones at each end of the tag. The monopole antenna does not suffer from this problem.

We have looked at using this embodiment on smartphone cases and other cases with some success. The range is only 1 metre; however; this is enough to sound an alarm when the phone has been removed from its location.

The inventive steps are not restricted to standard RFID Gen 2 RAIN systems. The embodiments can be made much smaller to operate in the 2.4 GHz bands or even the 5 GHz band, enabling smartphones and Wi-Fi networks to interrogate tags over long-range when they are configured with the correct protocol. Perhaps, one day, replacing NFC tags in most applications.

An unprecedented performance of a grounded monopole can still be achieved without the monopole being physically connected to the ground plane. A simple capacitive plate at the bottom of the monopole or any monopole structure can carry enough current to get the full benefit of the image antenna below the interposer or inside the metal to which the embodiment is attached.

The other embodiments show how the support frame can be changed to create a range of eco-friendly tags that open the door to single-use, long-read-range, on-metal tagging.

The option of a foam or cardboard tag functioning as a slap-and-ship, ‘on-anything’ tag or the utilisation of the packing materials for an in-anything tag is an exciting prospect for the future of RFID, the Internet of things and RAIN technology.

The invention has been described with reference to a preferred embodiment. However, it will be appreciated that variations and modifications can be effected by a person of ordinary skill in the art without departing from the scope of the invention.

Further aspects and embodiments of the invention are defined the following clauses:
Clause 1: A UHF on-metal RFID tag that capacitively couples to the metal item being tagged comprising a monopole antenna means a capacitive coupling means and a resonant impedance matching structure positioned partly or fully under the tag that can be re-positioned to provide frequency tuning of both the antenna and impedance match to the transponder integrated circuit.
Clause 2: a Tag as in clause 1 and all other clauses where the monopole antenna is of the inverted-L type.
Clause 3: A tag as in clause 1 and all other clauses and embodiments is enhanced for use on-metal and off-metal using a separate optional metallic interposer means between the tag and the item or items to be tagged.
Clause 4: A tag as in clause 1 and all other clauses and embodiments is enhanced for use on-metal and off-metal using a metallic interposer means fixed permanently to the base of the tag.
Clause 5: A tag as in clause 1 that has a supporting structure free from plastic or other polymer materials.
Clause 6: A tag as in clause 1 and all other clauses that has an inlay free from plastic or other polymer materials.
Clause 7: A plastic-free and so environmentally friendly on-metal tag as in clause 1 and all other clauses excluding clauses 8 and 9 that uses cardboard or corrugated cardboard means as its supporting structure and incorporates an inlay with a non-plastic substrate.
Clause 8: A tag as in clause 1 which uses plastic or any polymer as its supporting structure.
Clause 9: A tag as in clause 1 that uses a foam or packing foam means as its supporting structure.
Clause 10: A tag as in clause 1 where the supporting structure is any material that has a low conductivity and low permeability for example dry wood.
Clause 11: A tag as in clause 1 and all other clauses where the tuning of the matching structure is accomplished by positioning the inlay location on the supporting structure.
Clause 12: A tag as described in clause 1 and all other clauses where the tuning of the matching structure by positioning the inlay also tunes the monopole antenna means. (Note. By changing the antennas effective length).
Clause 13: A tag as in clause 1 and all other clauses where the resonant impedance matching structure is an elongated slot means in the inlays conductive layer.
Clause 14: A tag as in clause 1 where the impedance matching structure is designed with its length and width ratio so that when tuned by its position over metal it also changes the effective length of the attached antenna so that the antenna tuned frequency tracks and corresponds to the matching structure tuned frequency.
Clause 15: A tag as in clause 1 where the monopole antenna of any type contains meanders or squiggles.
Clause 16: A tag as in clause 1 that has holes or a mesh in the supporting structure as a means of reducing contact area with the inlay's antenna.
Clause 17: A tag as in clause 1 and all and other clauses and embodiments that incorporates an NFC (Near field communication) tag of any means.
Clause 18: A tag as in clause 1 that incorporates a single chip that contains both the UHF and NFC transponders.
Clause 19: A tag as in clause 1 and all other clauses which have a tamper detection loop means either on the UHF or NFC transponder circuits.
Clause 20: A tag as in clause 1 and all other clauses that has a temperature detection means either on the UHF or NFC transponder circuits.
Clause 21: A tag as described in clause 1 where the frequency of operation is in the worldwide bands for Bluetooth transponders.
Clause 22: A tag as described in clause 1 where the frequency of operation is in the worldwide bands for Wi-Fi transponders.
Clause 23: A tag as described in clause 1 where the frequency of operation is in the worldwide bands for mobile communication.
Clause 24: An on-metal tag as described in clause 1 where all or part of the metal antenna is replaced by a ceramic antenna means.
Claus 25: A long-range UHF RFID tag free from ferromagnetic and ceramic material is functional both on and off metal by incorporating a conductive interposer layer capacitively coupled to an inverted-L monopole antenna structure and also capacitively coupled to the item to be tagged wherein the resonant impedance matching structure attached to the antenna is an elongated resonant means positioned partly over the interposer to provide frequency tuning of both the antenna and impedance match to the transponder integrated circuit by moving its position.
Clause 26: A tag as in clause 25 where the impedance matching structure is designed as an elongated resonant structure with its length and width ratio set so that when tuned by its position over the interposer the length of the attached antenna is also changed so that the antenna tuned frequency tracks with the matching structures tuned frequency.
Clause 27: A tag as in clause 25 when used on a metal surface uses the metal to be tagged to re tune the matching network and antenna providing different tuning when the tag is on or off metal.
Clause 28: A tag as in clause 25 which uses plastic or any polymer as its supporting structure.
Clause 29: A tag as in clause 25 that has a supporting structure free from plastic or other polymer materials.
Clause 30: A tag as in clause 25 has an inlay free from plastic and other polymer materials.
Clause 31: A plastic-free environmentally friendly tag as in clauses 25, 29 and 30 where the supporting structure is cardboard or corrugated cardboard and incorporates an inlay with a non-plastic substrate.
Clause 32: A tag as in clause 25 that uses foam of any type, such as box packing material, as its supporting structure.
Clause 33: A tag as in clause 25 where the supporting structure is any material that has a low conductivity and low permeability for example dry wood.
Clause 34: A tag as in clause 25 and all other claims and embodiments that incorporates an NFC (Near field communication) tag of any type.
Clause 35: A tag as in clause 25 that incorporates a single chip that contains both the UHF and NFC transponders.
Clause 36: A tag as in clause 25 and all other clauses that include a tamper detection loop means either on the UHF or NFC transponder circuits.
Clause 37: A tag as in clause 25 and all other clauses that has a temperature detection means on either the UHF or NFC transponder.
Clause 38: A tag as in clause 25 where the frequency of operation is in the worldwide bands for Bluetooth transponders and/or Wi-Fi transponders and/or mobile communication.

1. A long-range UHF RFID tag functional both on and off metal comprises:
a chip comprising a transponder;
an inverted-L monopole antenna structure;
a resonant impedance matching structure attached to the antenna, which resonant impedance matching structure is in the form of an elongated resonant means; and
a conductive interposer layer capacitively coupled to the inverted-L monopole antenna structure,
wherein the resonant impedance matching structure is positioned partly over the interposer and wherein the resonant impedance matching structure is configured to provide frequency tuning of both the antenna and the resonant impedance matching structure to the transponder integrated circuit by moving its position, and optionally free from ferromagnetic and ceramic material.

2. The long-range UHF RFID tag as claimed in claim 1, which further comprises a supporting structure and an inlay on the supporting structure and, disposed on the inlay, the inverted-L monopole antenna structure, the resonant impedance matching structure and the chip containing the transponder.

3. The long-range UHF RFID tag as claimed in claim 2, wherein the inlay is free from plastic and other polymer materials.

4. The long-range UHF RFID tag as claimed in claim 2, wherein the interposer is disposed on a bottom of the supporting structure, the inverted-L monopole antenna structure being disposed on the top of the supporting structure.

5. The long-range UHF RFID tag as claimed in claim 2, wherein the support structure is discrete from an article or packaging article to which the tag is to be applied.

6. The long-range UHF RFID tag as claimed in claim 2, wherein the support structure forms part of an article or packaging article on which the tag is formed or is to be formed.

7. The long-range UHF RFID tag as claimed in claim 2, wherein the supporting structure is free from plastic or other polymer materials.

8. The long-range UHF RFID tag as claimed in claim 2, wherein the supporting structure is cardboard or corrugated cardboard.

9. The long-range UHF RFID tag as claimed in claim 8, which is a plastic-free environmentally friendly tag that incorporates an inlay with a non-plastic substrate.

10. The long-range UHF RFID tag as claimed in claim 2, wherein the supporting structure comprises a foam of any type.

11. The long-range UHF RFID tag as claimed in claim 2, wherein the supporting structure comprises a plastic or any polymer.

12. The long-range UHF RFID tag as claimed in claim 2, wherein the supporting structure is any material that has a low conductivity and low permeability.

13. The long-range UHF RFID tag as claimed in claim 1, wherein the resonant impedance matching structure is an elongated resonant structure with its length and width ratio set so that when tuned by its position over the interposer the length of the attached antenna is also changed so that the antenna tuned frequency tracks with the resonant impedance matching structure's tuned frequency.

14. The long-range UHF RFID tag as claimed in claim 1, which is configured to use a metal surface of an article or packaging article to be tagged to re-tune the resonant impedance matching structure and inverted-L monopole antenna structure providing different tuning when the tag is on or off metal.

15. The long-range UHF RFID tag as claimed in claim 1, that incorporates an NFC (Near Field Communication) tag of any type.

16. The long-range UHF RFID tag as claimed in claim 1, wherein a single chip contains both UHF and NFC transponders.

17. The long-range UHF RFID tag as claimed in claim 1, which comprises a UHF transponder circuit and optionally an NFC transponder circuit and further comprises a tamper detection loop means or a temperature detection means, each independently either on the UHF transponder circuit or the NFC transponder circuit.

18. (canceled)

19. The long-range UHF RFID tag as claimed in claim 1, wherein the frequency of operation is in the worldwide bands for Bluetooth transponders, Wi-Fi transponders, or mobile communication.

20. (canceled)

21. (canceled)

22. The long-range UHF RFID tag as claimed in claim 1, wherein the interposer is elongated so that the inverted-L monopole antenna structure is a half lambda resonant length when off-metal or elongated by the addition of meanders of any shape to improve off-metal performance.

23. (canceled)

24. (canceled)

25. An article or a packaging article comprising a long-range UHF RFID tag as defined in claim 1.
